(19) United States
(12) Patent Application Publication
(10) Pub. No.: US 2009/0049699 A1
(43) Pub. Date: Feb. 26, 2009

(54) Protective device for hand-held power tool

(75) Inventors: Karsten Frenzel, Dresden (DE); Hans Rupprecht, Munich (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/221,891

(22) Filed: Aug. 6, 2008

(30) Foreign Application Priority Data
Aug. 22, 2007 (DE) 10 2007 000 457.7

(51) Int. Cl. B27B 9/00

(52) U.S. Cl. 30/390

(57) ABSTRACT

A protective device for partially covering a working tool (11) of a hand-held power tool (10) includes a hood-shaped protective member including a tubular connection union (22) projecting therefrom, a closing element (25) in its closing position (31) which closes an opening (23) of the connection union (22) and in its release position (32) and which the opening (23) of the connection union (22) keeps open, and a pivot support (30) for pivotally supporting the closing element (25) for displacement between its closing (31) and release (32) positions.

### BACKGROUND OF THE INVENTION

1. Field of the Invention

The present invention relates to a protective device for partially covering a working tool in particular, a grinding or cutting tool of a hand-held power tool such as a grinding or cutting power tool.

2. Description of the Prior Art

The protective devices are mounted, when needed, on the hand-held power tools in order to shield the working tool during an operation. By shielding the working tool, the operator is protected against accelerated removable material particles or sparks. On the other hand, a protective device, which is closed over a large portion and is provided with a connection union, enables an effective suction of material particles by connection of a suction device to the connection union, such as, e.g., an industrial vacuum cleaner.

German Publication DE 35 25 092 A1 discloses a hand-held power tool which is formed as a cutting tool and in which a disc-shaped working tool such as, e.g., a circular saw, is rotated by a drive motor. The disc-shaped working tool is partially shielded by a protective device formed as a protective hood. During an operation of the power tool, the shielding or protective hood extends up to the processed element. The protective device has a connection or suction union to which a suction device can be connected.

The known protective device permits to achieve both the protection of the user against accelerated material particles and an effective suction upon connection of a suction device.

When a suction device is not connected to the suction union, often, grinding or saw dust or particles can be thrown out through the union during operation of the power tool, which is drawback.

German Publication DE 43 05 373 A1 also discloses a hand-held power tool which is formed as a cut-off power tool the working tool of which is formed as a cutting disc and is partially shielded by a protective device formed as a cover hood. The protective device is provided with a connection or suction union with which the protective device can be connected with a suction device.

The drawback of this device likewise consists in that the suction union of the protective device remains open when a suction device is not connected to the union and, during an operation of the power tool, particles or sparks can be discharged through the union.

Accordingly, an object of the present invention is to provide a protective device for a hand-held power tool in which the above-mentioned drawbacks of the known power tools are eliminated and which insures a reliable covering of the connection or suction union when the union is not connected with the suction device.

### SUMMARY OF THE INVENTION

This and other objects of the present invention, which will become apparent hereinafter, are achieved by providing a protective device for partially covering a working tool of a hand-held power tool, including a hood-shaped protective member having a tubular connection union projecting therefrom, a closing element having a closing position in which it closes the opening of the connection union, and a release position in which the opening of the connection union is open, and a pivot support for pivotally supporting the closing element for displacement between the closing and release positions.

The provision of the closing element arranged on a pivot support permits to close the connection union opening during an operation of the power tool without a suction device being connected to the connection union in order to prevent discharge of removable particles and sparks. The closing element consists of few parts. At the same time, the closing element, which is supported without a possibility of being lost, can be pivoted in a defined release position in which it cannot be damaged and keeps the union opening free.

Advantageously, the pivot support is arranged sideways of the union opening, so that the complete cross-section of the opening is accessible in the release position of the closing element.

It is advantageous when the closing element is formed as a closing cap having a support section and a closing section. The support section serves for mounting the closing cap on the pivot support. The closing section serves for closing the union opening. The closing cap can be easily technically produced.

According to a constructively simple embodiment of the inventive protective device the connection union has a projection that forms a counter-support section for the support section of the pivot support. The projection can be connected with the hood-shaped closing member, whereby the projection functions as protective device stiffening means.

In a technically simple embodiment of the pivot support, the pivot support has a support pin for pivotally connecting the support section and the counter-support section with each other and which extends through support openings provided in both the support section and the counter-support section.

Advantageously, at least one spring member is arranged between the closing element and the pivot support for retaining the closing element in both its closing position and its release position. The spring member insures, in a simple way, stable conditions of the closing element in the two defined positions and insures, in particular, a reliable closing of the union opening in the closing position of the closing element.

Advantageously, the at least one spring member is formed as a leaf spring fixedly secured to the closing element. In particular, the spring member can be formed as one piece with the closing element. Thereby, the spring member and the closing cap can be produced in one step, e.g., of a plastic material by injection-molding.

Advantageously, the at least one spring member and the support pin-receiving openings for receiving the support pin provide for retaining of the closing element eccentrically relative to the support pin in both the closing and release positions of the closing member. In this way, the closing positions of the closing member can be clearly defined in a simple manner.

Advantageously the counter-support section has a link guide engageable by a free end of the at least one spring member. Thereby, in a simple manner, a reliable positioning of the closing member is achieved in both its closing position and its release positions.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of hand-held power tool with an inventive protective device mounted thereon;

FIG. 2 a perspective view of a detail of the inventive protective device marked with sign II in FIG. 1 in a closing position of the closing element;

FIG. 3 a longitudinal cross-sectional view of the detail II in FIG. 2; and

FIG. 4 a longitudinal cross-sectional view of the detail II in FIG. 2 in an open position of the closing element.

### DETAILED DESCRIPTION OF THE PREFERRED EMBODIMENT

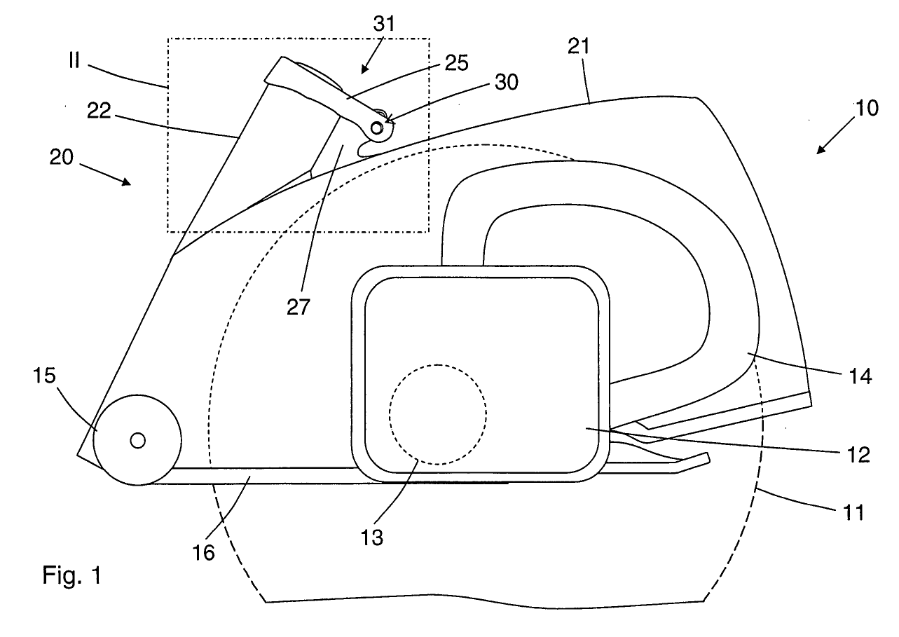

FIG. 1 shows a hand-held power tool 10 in form of a cutting tool such as, e.g., a hand-held circular saw having a disc-shaped working tool 11 driven by a motor 13 located in the circular saw housing 12. The hand-held power tool 10 further includes a guide shoe 16 with which the power tool 1 is placed on an object to be cut.

For protecting a tool-operating person from removable material particles, which are accelerated during operation of the power tool 10, the power tool 10 is provided with a protective device generally designated with a reference numeral 20. The protective device 20 has, to this end, a hood-shaped protective member 21 that partially surrounds the working tool 11 in a radial direction in form of a circular arc. The protective member 21 is secured by a connection region of the protective device 20, not visible in FIG. 1, on a working tool-side of the housing 12 of the hand-held power tool 10. The protective device 20 can be further provided with rollers 15 which improve guidance of the power tool 10 over the to-be-cut object.

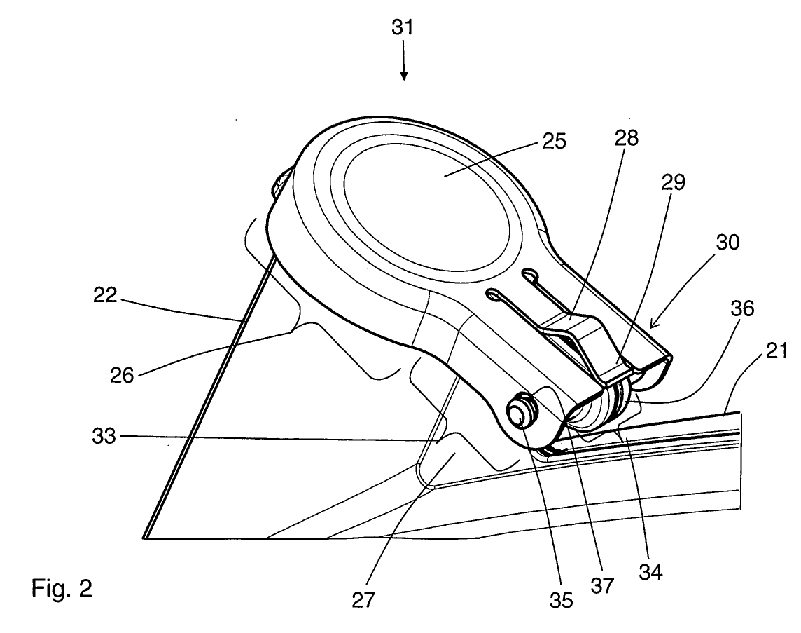

The protective device 20 is further provided with a tubular connection union 22 for a suction device such as, e.g., an industrial vacuum cleaner. At its end remote from the protective member 21, the connection union 22 is provided with a closing element 25 which is shown in FIGS. 1 and 2 in its closing position 31 in which an opening 23 of the connection union 22 is closed by the closing element 25. The closing element 25 is pivotally supported on a sidewise projection 27 of the connection union 22 by a pivot support 30.

The closing element 25 is formed of a closing section 26 and a support section 33. The support section 33 pivotally supports the closing element 25 on a counter-support section 34 of a pivot support 30 with a support pin 35 of the pivot support 30. The counter-support 34 is formed on the projection 27. In the support section 33 and in the counter-support section 34, there are provided support openings 37 for the support pin 35 that extends therethrough. Both support openings 37 in the support section 33 of the closing element 25 have a somewhat larger diameter than the support pin 35.

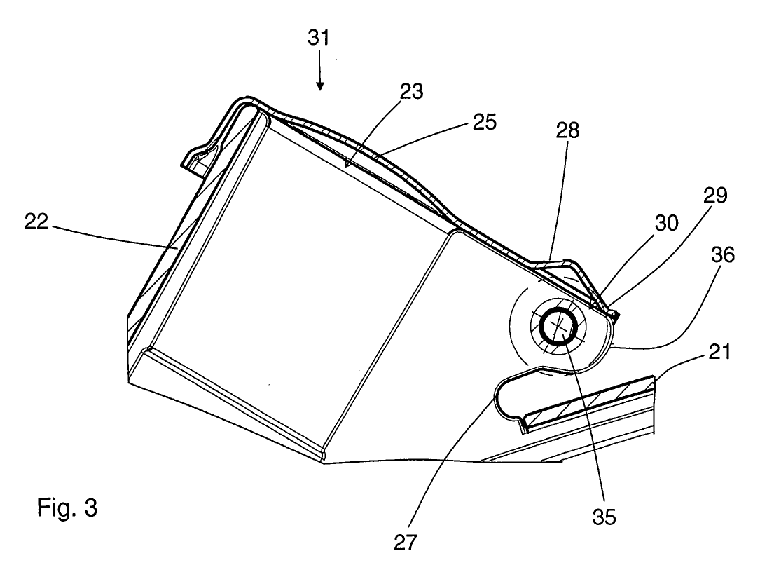

On the support section 33, there is arranged a spring member 28 formed as a leaf spring and formed integrally with the closing element 25. The spring member 28 has a free end 29 remote from the closing section 26 and engaging a link guide 36 provided on the counter-section 34. The spring member 28, which engages the link guide 36, retains the closing element 25 in its closing position shown in FIGS. 1 through 3 and in which the support pin 35 is eccentrically supported in the support openings 37 of the support section 33.

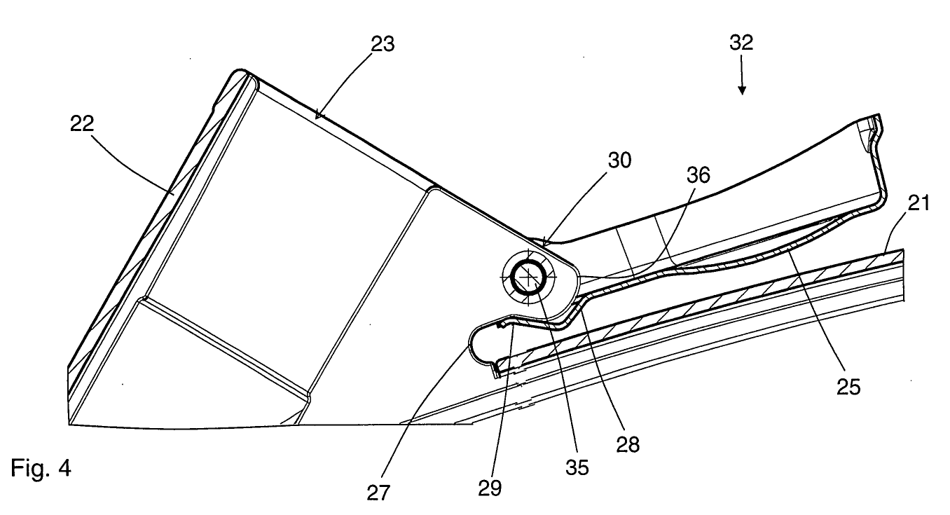

In FIG. 4, the closing element 25 is shown in its release position 32 in which the spring member 28 is guided with its free end 29 along the link guide 36 until the free end 29 reaches its park position shown in FIG. 4. The spring member 28 insures that the closing member 25 is locked-eccentrically with respect to the pivot pin 35 only in its closing position 31.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A protective device for partially covering a working tool (11) of a hand-held power tool (10), comprising:
a hood-shaped protective member including a tubular connection union (22) projecting therefrom and having an opening (23);
a closing element (25) having a closing position (31) in which it closes the opening (23) of the connection union (22), and a release position (32) in which the opening (23) of the connection union (22) is open; and
a pivot support (30) for pivotally supporting the closing element (25) for displacement between the closing (31) and release (32) positions thereof.

2. A protective device according to claim 1, wherein the pivot support (30) is arranged sidewise of the opening (23) of the connection union (22).

3. A protective device according to claim 1, wherein the closing element (25) is formed as a closing cap having a support section (33) and a closing section (26).

4. A protective device according to claim 3, wherein the connection union (22) has a projection (27) that forms a counter-support section (34) for the support section (33).

5. A protective device according to claim 4, wherein the pivot support (30) has a support pin (35) for pivotally connecting the support section (33) and the counter-support section (34) with each other and which extends through support openings (37) provided in both the support section (33) and the counter-support section (34).

6. A protective device according to claim 1, further comprising at least one spring member (28) arranged between the closing element (25) and the pivot support (30) for retaining the closing element (25) in both the closing position (31) thereof and the release position (32) thereof.

7. A protective device according to claim 6, wherein the at least one spring member (28) is formed as a leaf spring fixedly secured to the closing element (25).

8. A protective device according to claim 6 wherein the at least one spring member (28) and the support openings (37) for receiving the support pin (35) provide for retaining of the closing element (25) eccentrically relative to the support pin (35) in both the closing position (31) of the closing member (25) and the release position (32) thereof.

9. A protective device according to claim 5, wherein the counter-support section (34) has a link guide (36) engageable by a free end of the at least one spring member (28).
